(19) United States
(12) Patent Application Publication
(10) Pub. No.: US 2002/0194114 A1
(43) Pub. Date: Dec. 19, 2002

(54) Multi-dimensional representation of financial data

(76) Inventor: Lisa M. Erdmier, Winnetka, IL (US)

Correspondence Address: Lisa Erdmier, 545 Sheridan Road, Winnetka, IL, 60093, US

(21) Appl. No.: 10/122,990

(22) Filed: Apr. 15, 2002

Related U.S. Application Data
(60) Provisional application No. 60/284,124, filed on Apr. 16, 2001.

(51) Int. Cl. G06F 17/60

(52) U.S. Cl. 705/37; 705/36

(57) ABSTRACT

A method is described which enables a user to present on a single graph several attributes of the market behaviors of securities such as common stocks, options, commodities, and the like. It also enables a user to compare such attributes either along different time horizons, or to compare such attributes of two or more securities. In general, the prices are shown along the vertical direction, whereas an attribute such as volume would be shown as horizontal lines proportional to said volumes in length, and intersecting the price line at positions corresponding to the strike price. Comparisons of several securities as well as comparisons could be easily made, and historical information such as open, close, average, high, and low prices could also be provided though the use of proper legends such as colored lines, asterisks, and the like.

As the result of the increasing importance of the role which commercial securities as a component for asset management and as a major indicator of the health of the general economy, there has also been a steadily growing public awareness and interest in financial presentations. Most daily newspapers now report a list of selected stocks with their respective daily trading volumes, the trading ranges, and the closing prices. Some papers and other media (e.g., TV) also provide such information in graphical form, typically, a time-line graph showing the prices at selected time intervals (e.g., hourly, every 10 minutes, etc.)

To a large extent, there exists an important relationship between the market behavior of a security and its trading volume. The price of a security, like that of any other goods or services, is subject to the law of supply a demand. While there are many determinants which influence the price of a stock, the most important one is undoubtedly the perception of the prospect of future earnings. If there is a large number of traders who believe that such prospects warrant a certain price, the trading volume will be high, and vice versa. In other words, a good display of the history of a security should include not only the prices, but also the volumes at such prices. Indeed, whether viewed academically from the acclaimed efficient market theory, or technically from the momentum rule, the trading volume at different prices would be a useful indicator as to the movement of a market.

Although several methods exist to display the prices, volumes, and other information relating to the trading history of a security, some methods are useful only for persons who are highly trained in matters of securities transactions. Alternatively, some displays provide only very limited information. One example of this second type of displays is a display of only the daily trading ranges and the closing prices. A second example is a time-line graph of the price of a security. Displays of this type, though of interest, would not be able to provide much important information. In volatile markets such as we are experiencing in recent years, a variation of several percentage points (or much more) between the daily highs and lows for a given security has become more a general rule rather than a special situation. Without more specifics as to the volume in which a security is traded at certain price, the financial information is incomplete. or are useful only for a person well trained in the intricacies of securities transactions.

For today's markets, transparency and quickness are of importance not only to a professional trader, but also to the general investing public. This latter group, much larger in number than trained securities traders, would be benefitted by simple graphical displays of the history of both the prices and the trading volumes at such prices, and by simple graphical displays of historical boundary values such as the high, low, open, and close prices of a security during a period of interest to the specific investor.

It is therefore the objective of this invention to provide, at a glance, simple and yet comprehensive snapshots of the price-volume actions of a security from one time frame to a second time frame without the need for mechanically going through pages of data and making comparative evaluations either mentally or assisted by other means. If desired, a simplified and yet informative display could be made through the elimination of daily fluctuations and the use of boundary lines for the high and low prices for a time period of interest. Alternatively, market dynamics based on addition relevant data such the high, low, close, last trade, and the trading volumes at all trading prices could also be summarized on a single axis in a comparative form in a single a display that is easy to understand.

It is also the objective of the present invention to create a method for depicting both the price movements and the volumes of a publicly traded security. Such depiction can be dynamic, i.e., to reflect the instantaneous changes in price and volume, or static, i.e., at the conclusion of a trading period, e.g., one day. More specifically, it is the objective of this invention to depict the price in one dimension and the trading volume in a second dimension in the same sub-unit of a sewed time interval (e.g., one hour, one day, ten-minutes, etc.), and then depicting these sub-units sequentially by time. As the illustrations herein will show, one will then be able to visualize for any time interval the not only the high, low, and closing prices of a specific security, but also at what volume the security was (or is being)traded. Was a high or near high for that period a rare occurrence, or was it where most trades were completed? What was the sentiment at the close (or beginning) of the trading period. Or if drastic reversals or accelerations took place during the trading day, one can also easily trace all activities and coordinate them with specific events, e.g., either an anticipated or a surprise action taken by the Federal Reserve Board.

### Description of the Prior Art

In view of the importance of the financial market in a modern society, methods for depicting the prices of securities in chart form have been of interest to a number of inventors. In general, such inventions may be classified into two broad groups. The first group deals with the means for converting raw data into a display in accordance with a specified procedure. In U.S. Pat. No. 3,648,270, for example, Metz et al. described an apparatus for plotting simple stock market data with a means for storing a reference value, and for generating a dot on the display, initiating or terminating a line, and the like when a match is detected. In U.S. Pat. No. 3,731,387, Slemmons disclosed an apparatus for plotting stock market data. More recently, Black et al. disclosed in U.S. Pat. No. 6,012,042 a data conversion device which converts both technical and fundamental data about a security into a unified format for analysis by an analysis process engine in accordance with a set of rules and forwards the results to a display for viewing or used in further analysis. In U.S. Pat. No. 6,188,403 B1 and U.S. Pat. No. 6,222,540 B1, Sacerdoti et al. described versions of devices for the generation of 3D graphics for use in PC's and laptops in a business.

The second group deals with the creation of said specified procedure so as to achieve a desired mode of presentation. In U.S. Pat. No. 6,272,474B B1, for example, Garcia described a method for monitoring and trading stocks and providing stock information to traders. Information are gathered and displayed on a display screen as to includes bid offers, ask offers, the size of the bid offers, the size of the ask offers, the identity of the market makers making each offer, the volume of each trade, the time of each trade, and the price of each trade. The displayed screen includes a display of bid/ask trade bars for a stock or each of selected number of stocks in which percentage of sales at bid prices and percentage of sales at ask prices are depicted. Such a display, though useful to a professional trader, are beyond the practical use of the investing public. Similarly, in U.S. Pat. No. 5,966,139, Anupam et al.disclosed a method and system for visualing relatively large amounts of data in a limited space including segmenting the data, and mapping each segment to a node within the display space based on a specified nodal layout, texture mapping each graphical display of each segment of data to its node, and displaying the data in each node of the display space as mapped. Again, as it may be obvious from the specific description by the inventors, it is beyond the practical use by the general public. In U.S. Pat. No. 6,256,628 B1, Dobson et al. also disclosed a method of displaying clustered data points in detail and in context within a data set by identifying one or more clustered sets of data points within a data set which includes a plurality of data points, where each data range sea for each cluster of data points where each data range segment has a boundary and a scale interval, and displaying the data points in each segment such that each segment is mutually distinguishing. Examples of other methods which are useful to a professional trader but not to the general public include an invention of Nevo et al. in U.S. Pat. No. 5,946,666 for finding unusual price actions based on deviations from the norm; a data analysis system by Defarto in U.S. patent application Ser. No. 2002/00047 74A1 to keep track of the trading history of a trader of securities and other financial instruments and to display a trade profile of their trading behavior; and a charting method involving polygonal displays of financial data by Kuniko in Japan 10247210 A. In U.S. Pat. No. 5,339,392 (Aug. 16, 1994) is a software program Risberg et al. which enables a user to compose a custom active document using tools provided by the program. In U.S. Pat. No. 5,347,452, Bay, Jr. described a method for displaying market trading volume and trade volumes which deviates from the average. Sets of sequential markers for preselected time interval with amplitudes representing average volume of trades of a predetermined item during a preselected time interval taken over a predetermined number of the preselected time intervals are used, and are compared with a set of second markers substantially concurrently in time with the corresponding first markers and which are positioned on the graph in proximity to the corresponding first markers. Each second marker has an amplitude representing the volume of trades in the preselected time during the most recent preselected time intervals with the difference in amplitude indicative of trade volume deviations from average trading volume. In sum, these prior art, while useful to a highly trained professional trader, appears to be beyond the practical use of the general trading public.

### Preferred Embodiment of My Invention

My invention comprises the creation of charts which use a single axis to display data in the sense that the time element is integrated into the price and volume actions in the form of a modified bar diagram instead of the usual sequential display of time on the horizontal axis. As it will be shown, my invention enables a user to manipulate the time factor in a comparative form, and therefore to be able to show the comparative price action for two different time periods by the use of a common point (i.e., last closing price). Similarly, boundaries based on high, low, open, and close prices could also be displayed on said single axis in a comparative form. Furthermore, by showing the cumulative volumes at their respective prices in a side-by-side display, a user can compare at a glance the volume at each price for any two different time periods of interest.

Several specific embodiments of my invention are described below.

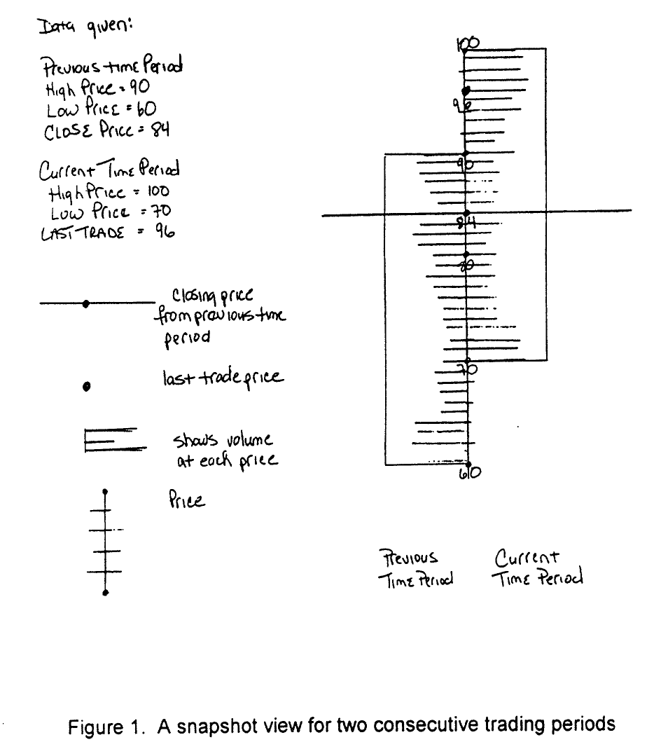

1. A snapshot view for two consecutive trading periods. A method for period-to-period presentation is illustrated in FIG. 1. The objective of this presentation is to give a simplified snapshot-view of the trading pattern of two consecutive periods,.and to give the trading range greater prominence than the closing price, and to provide information which is easier to visualize than a bar chart. Specifically, this method of presentation shows the high/low prices of the previous period (e.g., day) as compared to the high/low prices of the current period (e.g., today). The close from the previous day is shown in a horizontal line through both period. The volume is given at all trading prices, and the last trade (close) price is also shown. In my specific example, the relevant data are as follows:

| | | | Last Trade or |
|---|---|---|---|
| Period | High Price | Low Price | Close Price |
| Previous | 90 | 60 | 84 |
| Current | 100 | 70 | 96 |

The vertical axis shows the price, the horizontal bars show the volume, and the two consecutive time periods (previous and current) are drawn next to each other in the form of closed “boxes” and the upper and lower boundaries show the high/low prices for each period. By showing the direct price comparison, this gives the numbers greater value.

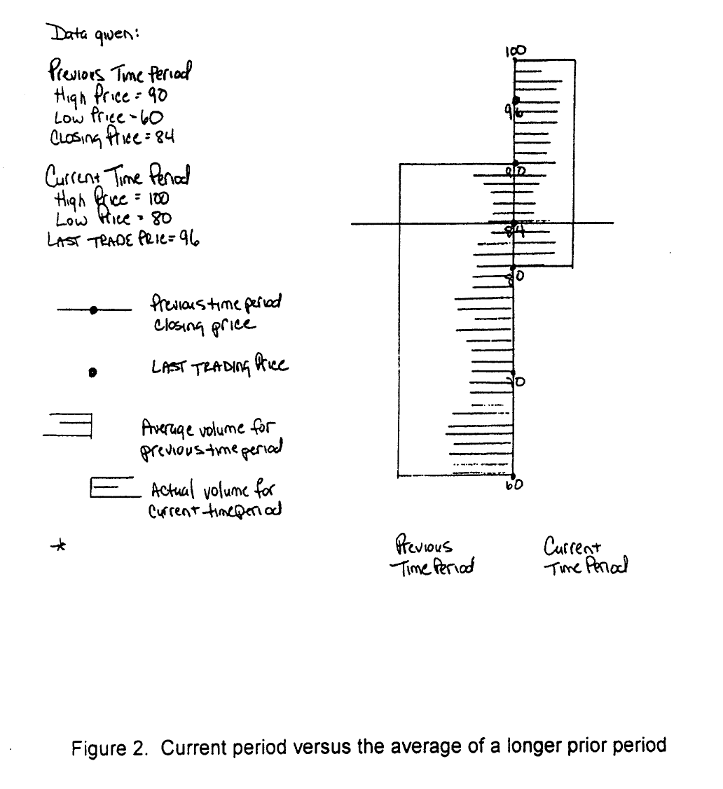

2. Current period versus average of a longer prior period. FIG. 2 is similar to FIG. 1, but is included to show the flexibility of my method, i.e, the two time periods need not be of the same length because it may be useful sometimes to have a quick view of a longer prior period, and furthermore, it provides a measure of the weight (volume traded) of the various prices and thereby enables one to determine the relative strength or weakness of a given price of interest. Specifically, this figure shows the information for the previous week as compared to today. It is important to note that, to be meaningful, the volume for the previous week must be “normalized” by using an average daily volume which can of course be easily determined by summing the daily volumes and then divide the total by the number of trading days. In my specific example, the relevant data are as follows:

| | | | Last Trade or |
|---|---|---|---|
| Period | High Price | Low Price | Close Price |
| Previous | 90 | 60 | 84 |
| Current | 100 | 80 | 96 |

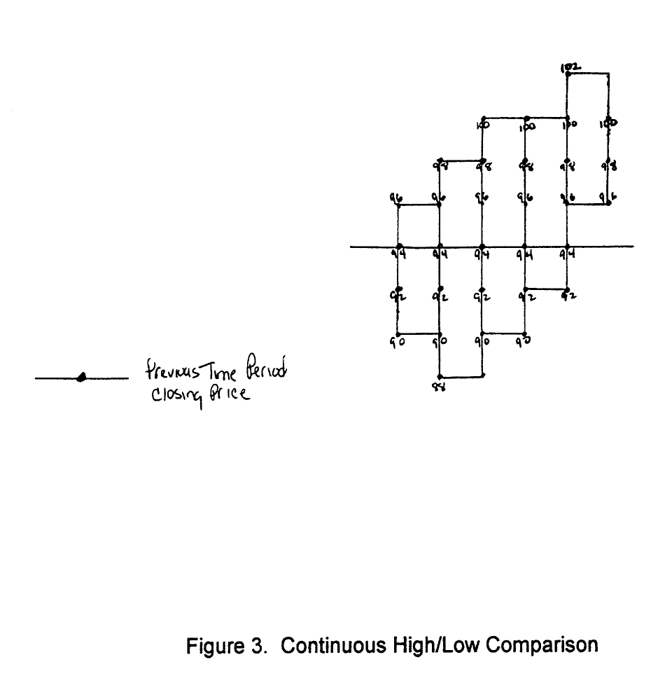

3. Continuous high/low comparison. FIG. 3 is a figure for a continuous high/low price comparison, the volume for each price, and the last trade for both periods. If this figure is used for an inter-day comparison, then the close of the previous day, but the last trade of the current period, should be used. In my specific example, the relevant data are as follows:

| | | | Last Trade or |
|---|---|---|---|
| Period | High Price | Low Price | Close Price |
| Previous | 90 | 60 | 84 |
| Current | 100 | 70 | 94 |

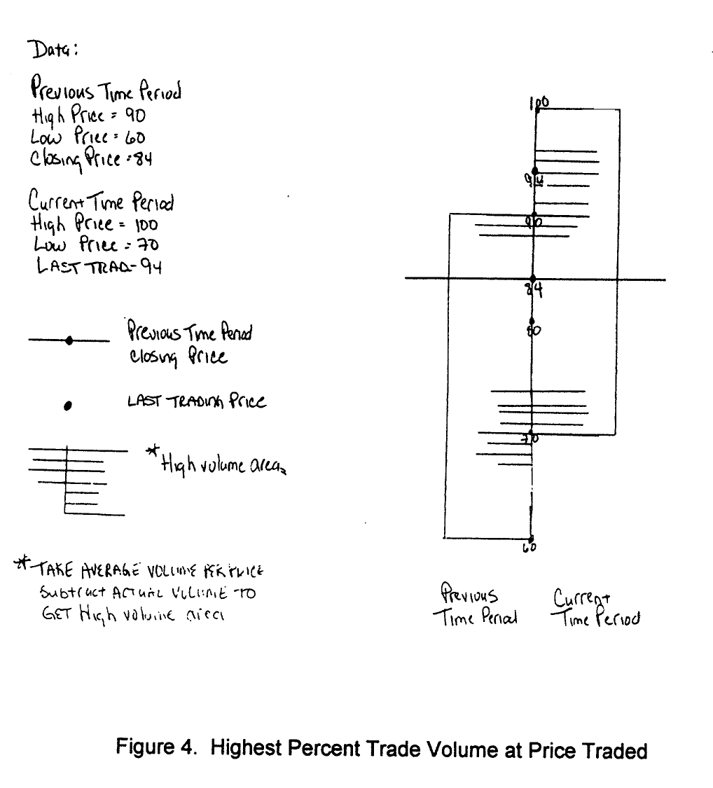

4. High-volume areas emphasized. The purpose of FIG. 4 is to emphasize the high volume areas as follows:

Volume shown=Average volume−Actual volume

Otherwise, the same general procedure used in FIG. 1 is again used, i.e., the boundaries are drawn to show the high/low prices and the close of the previous day is also shown. Also, as I did for FIG. 2, the time element can be varied and need not be of the same length of time.

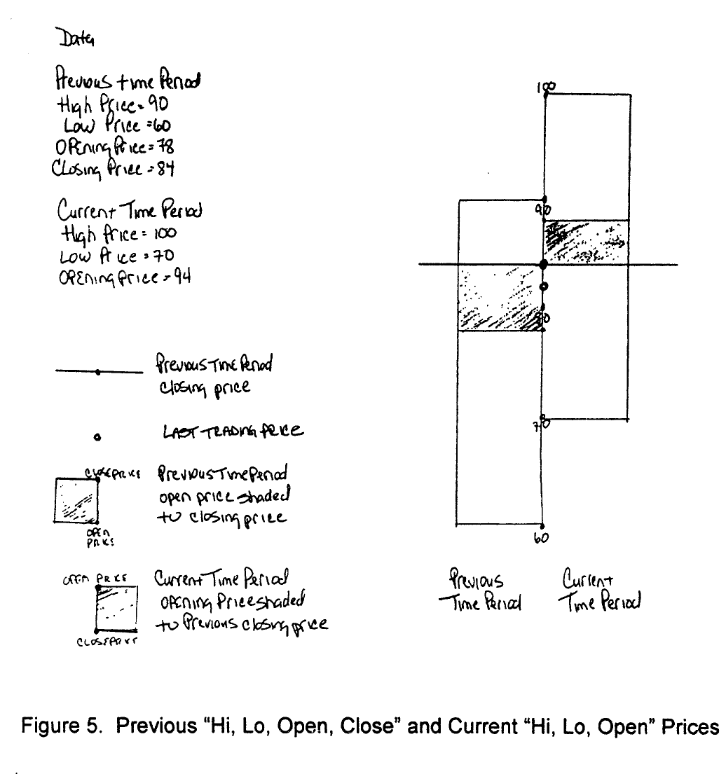

5. Open to Close. FIG. 5 shows the opening and prices of both the current and the previous periods together with the closing price of the previous period. In my specific example, the relevant data are as follows:

| | | | Opening | Last Trade or |
|---|---|---|---|---|
| Period | High Price | Low Price | Price | Close Price |
| Previous | 90 | 60 | 78 | 84 |
| Current | 100 | 70 | — | 94 |

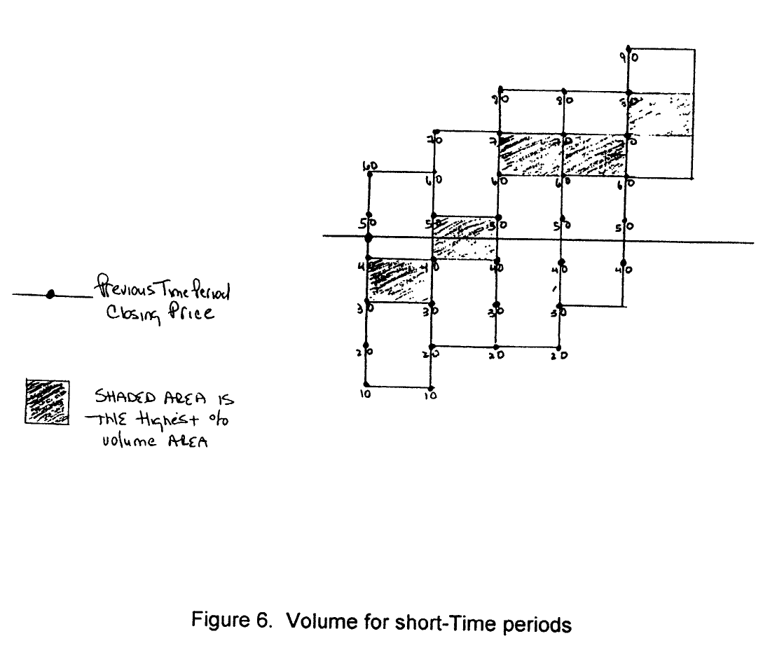

6. Volume for short-Time periods. FIG. 6 is a presentation which incorporates the concepts in both FIG. 3 and FIG. 5 by shading the area with the highest volume. As in previous figures, the closing prices for the previous period are shown as indicated by the legends therein.

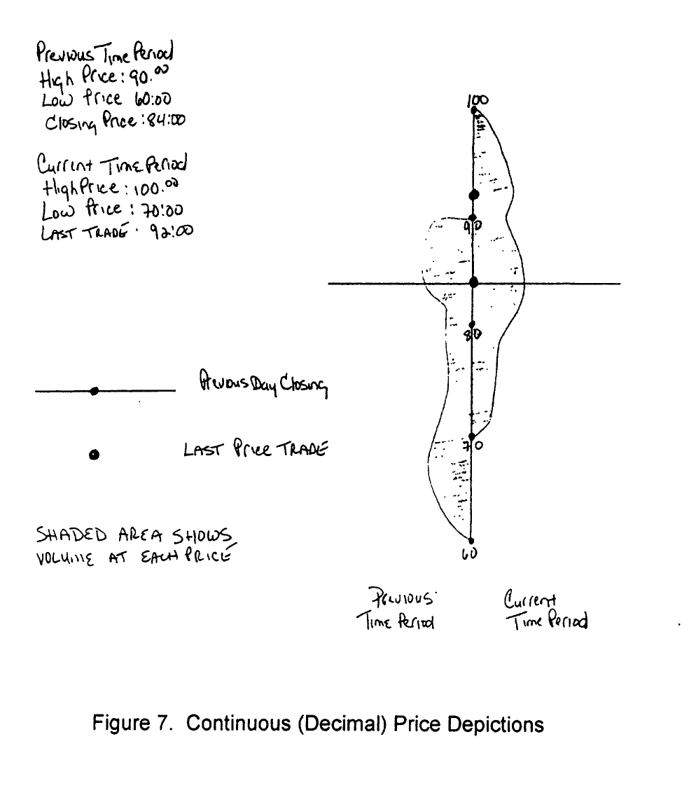

7. Continuous Price Depictions. FIG. 7 is an illustration as to how we can present the data in the entire price range by using shaded areas to shown the trading volumes at each price. This may become more and more important in view of the fact prices on the New York Stock Exchange has now been converted into the decimal system. In my specific example, the relevant data are as follows:

| | | | Last Trade or |
|---|---|---|---|
| Period | High Price | Low Price | Close Price |
| Previous | 90.00 | 60.00 | 84.00 |
| Current | 100.00 | 70.00 | 94.00 |

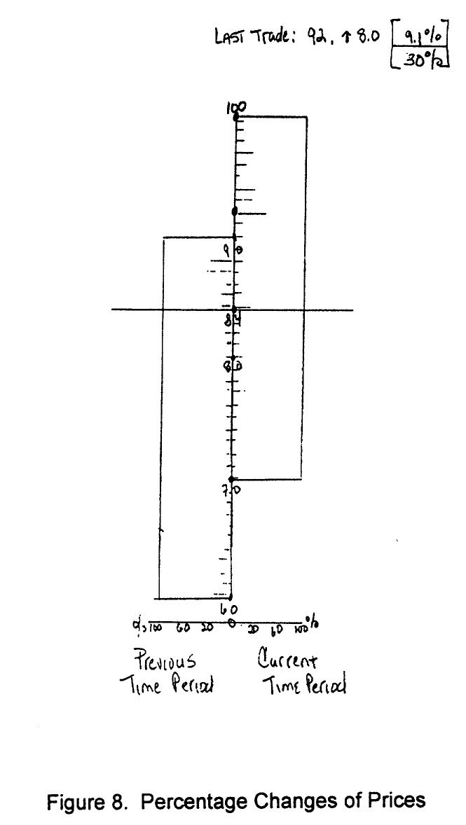

8. Percent Change of Prices. FIG. 8 is similar to FIG. 1, but provides additional information as to the percentage change in price from the closing price of the previous trading period as well as the percent of volume traded at specific prices for two different securities, e.g., those of the common stocks of Hewlett Packard and IBM.

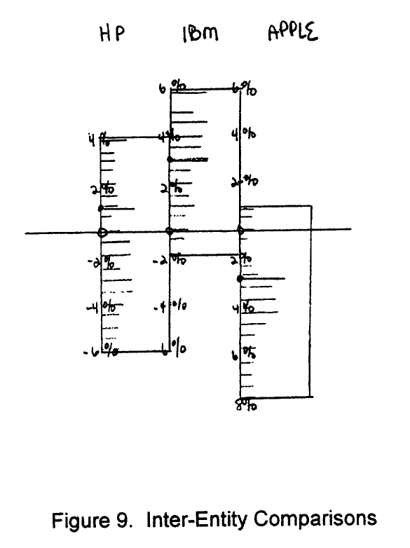

9. Inter-Entity Comparisons. FIG. 9 is a further extension of my method which would enable a person to examine the price behavior of several entities. In order to make the comparison meaningful, the data need to be shown in terms of percent changes, with

0=no change from previous price.

+=increase from previous price, and

−=decrease from previous price.

In my specific example, the figure shows that HP has a 4 percent gain and a 6 percent decline respectively from the previous close. Similarly, IBM had a 6 percent gain and a 2 percent decline from the previous close, and Apple had a 1 percent gain and an 8 percent decline from the previous close. The number of entities which can be so depicted is, of course, unlimited, and more can be shown in a similar manner.

It should be understood that the foregoing descriptions are only for illustrative purpose only, and are not intended to limit the scope of this invention. Rather, there are numerous equivalents to the preferred embodiments which would be obvious to those skilled in the art, and such are intended to be covered by this disclosures detailed in this provision application.

I claim:

1. An improved method for providing securities information to invests and traders, comprising the steps of:
A) retrieving and receiving securities trading information, said securities trading information comprising:
1) closing price for a security or selected securities from a previous period,
2) securities prices and trading volumes at said prices for said security or securities in a previous period, and
3) securities prices and trading volumes at said prices for said securities or securities in a current period, and
4) last trading price and trading volumes of said security or securities in said current period.
B) displaying securities-trading information and said trade information in the form of a chart on a display screen or paper, said chart comprising line displays of prices and the corresponding volumes both for said previous period and said current period.

2. A method as in claim 1, wherein said securities information is displayed either through a printed medium such as newspapers, magazines, or journals, or an electronic medium such as Television, the Internet, the ECN, or the like.

3. A method as in claim 1, wherein said securities trading information in said chart comprises:
A) open price for a security or selected securities from a previous period or periods, and
B) closing price for a security or selected securities from a previous period periods, and
C) security prices and trading volumes at said prices for said security or securities in a previous period or periods, and
D) open price for a security or selected securities for a current period.
E) prices and trading volumes at said prices for said security or securities in said current period, and
F) last trading price and trading volumes of said security or securities in said current period.

4. A method as in claim 1, wherein said securities trading information comprises:
A) a first area representing said previous trading period, and
B) a second area in the proximity of said first vertical area, said second area representing the current trading period, and
C) a vertical axis identifying said securities prices, and,
D) horizontal lines located in the first area at vertical locations corresponding to said trading prices in the previous period, and lengths proportional to said trading volumes at said trading prices in the previous period.
E) horizontal lines located in the second area at vertical locations corresponding to said trading prices in the current period, and lengths proportional to said trading volumes at said trading prices in the current period.

5. A method as in claim 1, wherein said securities trading information comprises:
A) a first area representing said previous trading period, and
B) a second area in the proximity of said first vertical area, said second area representing the current trading period, and
C) a vertical axis identifying said securities prices, and,
D) a rectangular area located in the first vertical area having an upper boundary depicting the open prices and a lower boundary depicting the close prices of said previous period, and
E) a rectangular area located in the second vertical area having an upper body depicting the open price of said current period and a lower boundary depicting the close price of said current period.

6. A method as in claim 1, wherein said securities trading information comprises:
A) a first area representing said previous trading period, and
B) a second area in the proximity of said first vertical area, said second area representing the current trading period, and
C) a vertical axis identifying said securities prices, and,
D) a rectangular area located in the first vertical area with an upper boundary depicting the high price and a lower boundary depicting the low price of said previous period, and
E) a rectangular area located in the second vertical area with lower boundary depicting the high and low prices of said current period.

7. A method as in claim 1, wherein said securities trading information comprises:
A) a first section comprising a plurality of rectangular areas representing said previous trading periods, and
B) a second section comprising a rectangular area in the proximity of said first section, said second section representing the current trading period, and
C) a vertical axis identifying said securities prices, and,
D) horizontal lines located i the verticalareas of said first section at vertical locations corresponding to said trading prices in the previous period, and lengths proportional to said trading volumes at said trading prices in the previous period.
E) horizontal lines located in the second vertical area at vertical locations corresponding to said trading prices in the current period, and lengths proportional to said trading volumes at said trading prices in the current period.

8. A method as in claim 1, wherein said securities trading information comprises:
A) a first section comprising a plurality of vertical areas representing said previous trading periods, and
B) a second section comprising a vertical area in the proximity of said first section, said second section representing the current trading period, and
C) a vertical axis identifying said securities prices, and,
D) a rectangular area located in the vertical areas of the first section wherein the upper and lower boundaries of said rectangular areas designate the open and close prices of said previous periods, and
E) a rectangular area located in the second vertical area wherein the upper and lower boundaries of said rectangular areas designate the open and last prices of said current period.

9. A method as in claim 4, wherein said lines comprise solid lines, broken lines, colored lines, dotted lines, and lines consisting of symbols such as squares, circles, and asterisks.

10. A method as in claim 1, wherein said securities comprise stocks, options, futures, commodities, and the like.
